(19) United States
(12) Patent Application Publication
(10) Pub. No.: US 2020/0371987 A1
(43) Pub. Date: Nov. 26, 2020

(54) CONTROL SYSTEM FOR PROGRAMMING CPLD AND METHOD THEREOF

(71) Applicant: NANNING FUGUI PRECISION INDUSTRIAL CO., LTD., Nanning (CN)

(72) Inventor: YAO-TSUNG CHANG, New Taipei (TW)

(21) Appl. No.: 16/418,409

(22) Filed: May 21, 2019

(51) Int. Cl. G06F 13/42; G06F 13/20

(52) U.S. Cl. CPC G06F 13/4291; G06F 13/20

(57) ABSTRACT

A system for controlling the programming of a CPLD includes an upper computer and a logic control unit. The logic control unit includes a processing module, a signal converting module, and a programming interface. The upper computer converts programming data into bus signals. When the processing module determines that the bus signals can be converted into signals suitable for the JTAG standard interface, the signal converting module outputs the interface signals to the programming interface. A programming control method is also disclosed.

### FIELD

The subject matter herein generally relates to programming control.

### BACKGROUND

Manufacturers of Complex Programmable Logic Devices (CPLDs) can use the CPU bus (SPI, LPC, I2C) to be converted to the general-purpose input and output (GPIO) bus to control the JTAG (Joint Test Action Group) interface to write to the CPLD. Generally, the GPIO bus does not have a data acceleration mechanism, and one command is used to control a change of the programming signal.

Therefore there is a room for improvement.

### BRIEF DESCRIPTION OF THE DRAWINGS

Implementations of the present disclosure will now be described, by way of embodiment, with reference to the attached figures.

FIG. 1 is a block diagram of an embodiment of a control system for programming in the present disclosure, which includes a signal converting module.

FIG. 2 is a schematic diagram of an embodiment of the signal converting module of FIG. 1 converting a bus signal into an interface signal.

FIG. 3 is a flowchart of an embodiment of a method for controlling programming of the present disclosure.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising” means “including, but not necessarily limited to”; it specifically indicates open-ended inclusion or membership in a so-described combination, group, series, and the like.

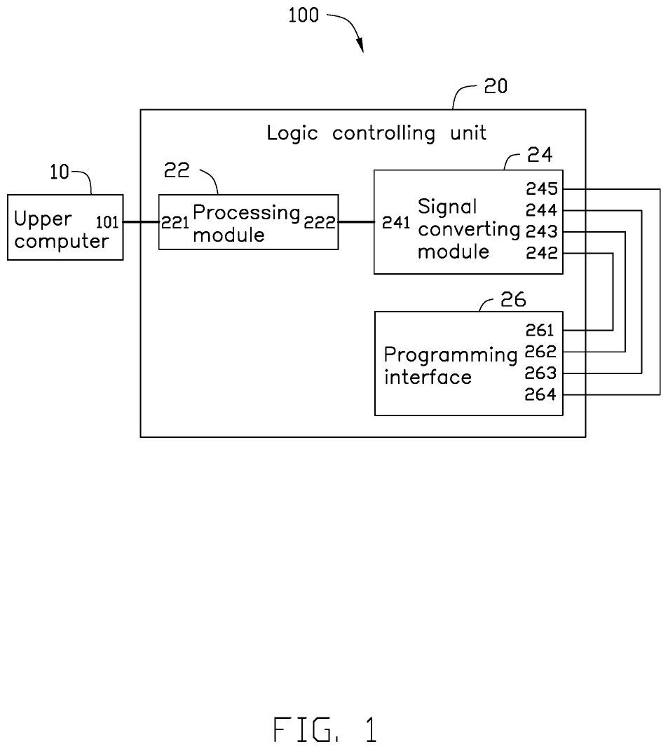

FIG. 1 illustrates a programming control system 100 in accordance with an embodiment of the present disclosure.

The programming control system 100 includes an upper computer 10 and a logic controlling unit 20.

The upper computer 10 includes an output terminal 101. The output terminal 101 of the upper computer 10 is electrically coupled to the logic controlling unit 20.

In at least one embodiment, the upper computer 10 converts programming data into bus signals and outputs the bus signals through the output terminal 101. The upper computer 10 is configured to program the logic controlling unit 20.

The logic controlling unit 20 includes a processing module 22, a signal converting module 24, and a programming interface 26.

In at least one embodiment, the processing module 22 is electrically coupled to the output terminal 101 of the upper computer 10, and the signal converting module 24 is electrically coupled between the processing module 22 and the programming interface 26.

The processing module 22 receives the bus signals and determines whether the logic controlling unit 20 can convert the bus signals into signals for the interface.

If the logic controlling unit 20 can so convert the bus signals, the processing module 22 outputs the bus signals to the signal converting module 24. The signal converting module 24 converts the bus signals into signals for the interface, and thereby programs the logic controlling unit 20. In the embodiment, the signals for the interface can include clock signal and data signal.

In at least one embodiment, the bus signals can be serial peripheral interface (SPI) signals.

In at least one embodiment, the signals for the interface can be signals meeting the JTAG standard.

In the embodiment, the signal converting module 24 converts the SPI signals into the JTAG signals. For example, the signal converting module 24 converts the MOSI signal and the MISO signal in the SPI signals into TDI/TMS signals and TDO signals. The TDI signal is the test data input signal, the TDO signal is the test data output signal, the TMS signal is the test mode selection signal, the MOSI signal is the main device data output signal, and the MISO signal is the main device data input signal.

In at least one embodiment, the processing module 22 includes an input terminal 221 and an output terminal 222. The output terminal 101 of the upper computer 10 is electrically coupled to the input terminal 221 of the processing module 22.

The signal converting module 24 includes an input terminal 241, an input terminal 242, an output terminal 243, an output terminal 244, and an output terminal 245. The output terminal of the processing module 22 is electrically coupled to the input terminal 241 of the signal converting module 24.

The programming interface 26 includes an output terminal 261, an input terminal 262, an input terminal 263, and an input terminal 264. The output terminal 243 of the signal converting module 24 is electrically coupled to the input terminal 262 of the programming interface 26. The output terminal 244 of the signal converting module 24 is electrically coupled to the input terminal 263 of the programming interface 26. The output terminal 245 of the signal converting module 24 is electrically coupled to the input terminal 264 of the programming interface 26. The input terminal 242 of the signal converting module 24 is electrically coupled to the output terminal 261 of the programming interface 26.

In one embodiment, the programming interface 26 receives programming signals. The programming signals can include clock signals, data signals, and mode selection signals.

In one embodiment, the programming interface 26 can be a JTAG standard interface, and the logic controlling unit 20 can be a CPLD.

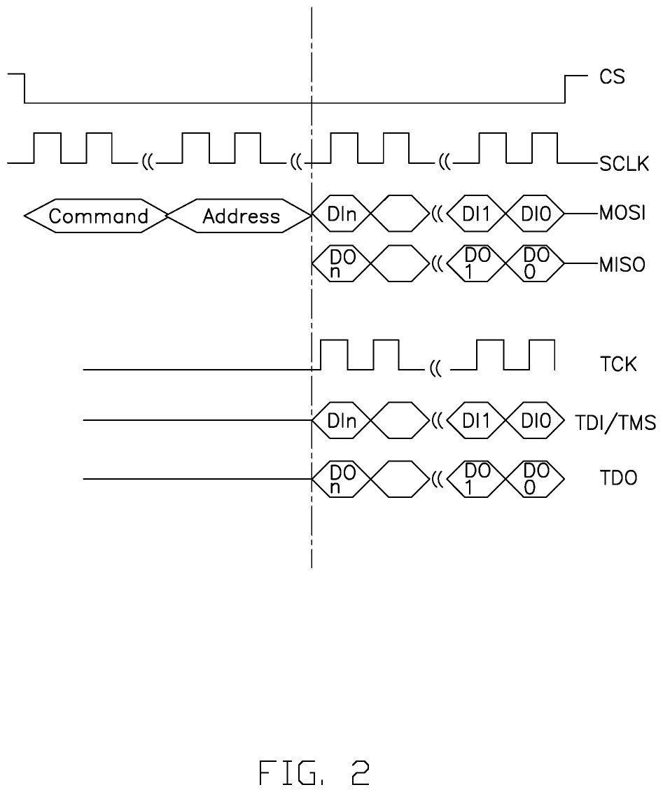

FIG. 2 illustrates the signal converting module converting the SPI signals into the JTAG signals.

In FIG. 2, the waveform CS is an enable signal in the SPI signal and is controlled by the upper computer 10. The clock signal shown by the waveform SCLK is used as the clock signal of the input JTAG interface. The data output signal shown by the waveform MOSI is used as the TMS signal or TDI signal of the JTAG interface. The data input signal shown by the waveform MISO can be used as the TDO signal of the JTAG interface. When the data output signal shown by the waveform MOSI is input as TDI data, the TMS signal maintains a low state.

In the embodiment, the command in the waveform MOSI and the Address command can be flexibly defined as the data transfer of the TMS signal or the TDI signal or the TDO signal.

When the signal conversion starts, the clock signal of the JTAG interface shown by the waveform TCK corresponds to the clock signal in the SPI signal. The data input signal of the JTAG interface shown by the waveform TDI/TMS corresponds to the data output signal in the SPI signal, and the data output signal of the JTAG interface shown by the waveform TDO corresponds to the input signal in the SPI signal.

In the embodiment, the TMS signal controls state of the JTAG interface, and the TDI signal and the TDO signal constitute data transmission for the JTAG interface.

As can be seen from FIG. 2, when the signal converting module 24 receives a trigger signal from the processing module 22, the signal converting module 24 begins to convert the SCLK signal, the MOSI signal, and the MISO signal in the SPI signal into a TCK signal, a TDI or a TMS signal, and a TDO signal as the JTAG interface signal.

In use, the output terminal 101 of the upper computer 10 outputs the SPI signal to the input terminal 221 of the processing module 22. When the processing module 22 determines that the SPI signal can be converted to the JTAG interface signal, the output terminal 222 of the processing module 22 outputs the SPI signal to the input terminal 241 of the signal converting module 24, and the signal converting module 24 converts the SPI signal into the JTAG interface signal.

The output terminal 243 of the signal converting module 24 outputs the data signals to the input terminal 262 of the programming interface 26, the output terminal 244 of the signal converting module 24 outputs the mode selection signals to the input terminal 263 of the programming interface 26, and the output terminal 245 of the signal converting module 24 outputs the mode clock signals to the input terminal 264 of the programming interface 26. The output terminal 261 of the programming interface 26 outputs a test signal to test a goal node reading/writing function of the logic controlling unit 20.

In the embodiment, the logic controlling unit 20 can include a test access port (TAP) to receive the JTAG interface signal.

The logic control unit 20 converts the SPI signal into a complete JTAG interface signal during a clock signal period of the SPI signal. The clock signal period of the SPI signal includes a falling edge changing to a rising edge. Thereby, the logic control unit 20 writes or reads the programming signal without temporary storage being required.

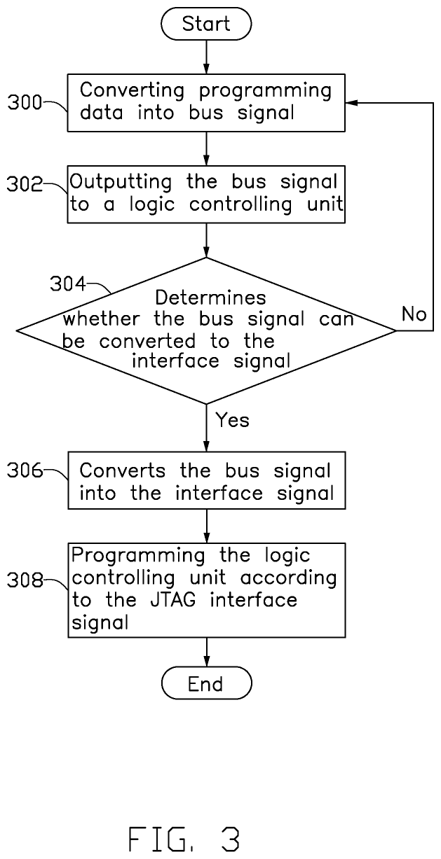

FIG. 3 is flowchart depicting an embodiment of a programming control method. The method is provided by way of example, as there are a variety of ways to carry out the method. The method described below can be carried out using the configurations illustrated in FIGS. 1-2 for example, and various elements of these figures are referenced in explaining the example method. Each block shown in FIG. 3 represents one or more processes, methods, or subroutines, carried out in the example method. Furthermore, the illustrated order of blocks is illustrative only and the order of the blocks can change. Additional blocks can be added or fewer blocks may be utilized, without departing from the present disclosure. The example method can begin at block 300.

At block 300, the upper computer 10 converts the programming data into the bus signals.

In the embodiment, the bus signals can be SPI signals.

At block 302, the upper computer 10 outputs the bus signals to the logic controlling unit 20.

At block 304, the processing module 22 determines whether that the bus signals can be converted to the signals for interface. If the bus signals can be converted to the signals for interface, block 306 is implemented, otherwise returns to block 300.

In the embodiment, the processing module 22 determines whether that the SPI signals can be converted to the JTAG signals.

In the embodiment, the interface signal can be the JTAG standard signals.

In the embodiment, the signal converting module 24 converts the SPI signals into the JTAG signals. For example, the signal converting module 24 converts the MOSI signal and the MISO signal in the SPI signal into TDI/TMS signals and TDO signals. The TDI signal is the test data input signal, the TDO signal is the test data output signal, the TMS signal is the test mode selection signal, the MOSI signal is the main device data output signal, and the MISO signal is the main device data input signal.

At block 306, the signal converting module 24 converts the bus signals into the JTAG signals.

In the embodiment, the signal converting module 24 converts the SPI signals into the JTAG signals.

At block 308, the logic controlling unit 20 is programmed according to the JTAG interface signal.

Even though numerous characteristics and advantages of the present technology have been set forth in the foregoing description, together with details of the structure and function of the present disclosure, the disclosure is illustrative only, and changes may be made in the detail, especially in matters of shape, size, and arrangement of the parts within the principles of the present disclosure, up to and including the full extent established by the broad general meaning of the terms used in the claims. It will therefore be appreciated that the embodiments described above may be modified within the scope of the claims.

1. A programming control system comprising:
an upper computer converting programming data into bus signals; and
a logic controlling unit coupling the upper computer and receiving the bus signals, and comprising:
a programming interface;
a processing module receiving the bus signals and determining whether the bus signal can be converted into signals for interface; wherein the processing module outputs the bus signals when the processing module determines that the bus signals can be converted into the signals for interface; and
a signal converting module receiving the bus signals and converting the bus signals into the signals for interface; wherein the signal converting module outputs the signals for interface to the programming interface to program the logic controlling unit.

2. The programming control system of claim 1, wherein the upper computer comprises a first output terminal, the processing module comprises a first input terminal, and the first output terminal of the upper computer is electrically coupled to the first input terminal of the processing module, to receive the bus signals.

3. The programming control system of claim 2, wherein the programming interface comprises a first output terminal, a first input terminal, a second input terminal, and a third input terminal, the signal converting module further comprises a second input terminal, a first output terminal, a second output terminal, and a third output terminal; wherein the first output terminal, the second output terminal, and the third output terminal of the signal converting module are electrically coupled to the first input terminal, the second input terminal, and the third input terminal of the programming interface, respectively.

4. The programming control system of claim 3, wherein the second input terminal of the signal converting module is electrically coupled to the first output terminal of the programming interface.

5. The programming control system of claim 1, wherein the signals for interface is joint test action group (JTAG) interface signal.

6. The programming control system of claim 5, wherein the signals for interface comprises clock signal and data signal.

7. The programming control system of claim 1, wherein the bus signals is serial peripheral interface (SPI) signals.

8. The programming control system of claim 1, wherein the logic controlling unit is a complex programmable logic device (CPLD).

9. The programming control system of claim 1, wherein the programming interface is a joint test action group (JTAG) interface.

10. The programming control system of claim 1, wherein the logic control unit converts the bus signals into a complete interface signal during a clock signal period of the bus signals, the clock signal period comprises a falling edge changing to a rising edge.

11. A programming method, comprising:
converting programming data into bus signals, wherein the bus signals is serial peripheral interface (SPI) signals;
outputting the bus signals to a logic controlling unit;
determining whether the bus signals can be converted into signals for interface;
converting the bus signals into the signal for interface when the bus signals is determined that can be converted into the signals for interface; and
programming the logic controlling unit according to the signals for interface.

12. The programming control method of claim 11, wherein the signals for interface is joint test action group (JTAG) interface signals.

13. The programming control method of claim 12, wherein the signals for interface comprises clock signal and data signal.

14. (canceled)

15. The programming control method of claim 11, wherein the logic controlling unit is a complex programmable logic device (CPLD).

16. The programming control method of claim 11, wherein the logic controlling unit further comprises a programming interface, wherein the programming interface is a joint test action group (JTAG) interface.
